(19) United States
(12) Patent Application Publication
(10) Pub. No.: US 2019/0022874 A1
(43) Pub. Date: Jan. 24, 2019

(54) SUCTION DEVICE

(71) Applicant: Helen of Troy Limited, Belleville (BB)

(72) Inventors: Martin Mutch, New York, NY (US); Tiffany Chen, New York, NY (US); Sunny Kim, Douglaston, NY (US); Troy Phipps, Brooklyn, NY (US)

(21) Appl. No.: 15/653,714

(22) Filed: Jul. 19, 2017

(51) Int. Cl. B25J 15/06

(52) U.S. Cl. CPC B25J 15/0683; B25J 15/0675; B25J 15/065

(57) ABSTRACT

A suction device includes a suction pad, an article holder connected with the suction pad, and a skirt extending away from the article holder toward the suction pad. The suction pad has a contact surface configured to be adhered to a support surface. The article holder connects with the suction pad. The skirt extends away from the article holder toward the suction pad and is positioned with respect to the suction pad so as to inhibit access to the suction pad when the suction pad with the article holder connected thereto is adhered to the support surface. The skirt defines an access passage when the suction pad with the article holder connected thereto is adhered to the support surface. The access passage is configured to allow an operator's finger access to the suction pad through the access passage.

### BACKGROUND

It is often desirable to secure articles to surfaces to inhibit the removal or movement of the article with respect to the surface. Oftentimes, this securement is desired for only a temporary period. Suction devices are often used to secure such articles temporarily.

In one particular example, when the aforementioned article is holding a young child's food, it can be desirable to inhibit the child from being able to easily remove the article from the support surface. Other examples include temporarily securing articles such as food processing devices that are used in the kitchen to the counter surface that supports the food processing device. There are many other similar examples of where it can be useful to temporarily secure an article to a support surface; however, it is also desirable to allow one to easily remove the article from the support surface when desired.

### SUMMARY

In view of the foregoing, a suction device includes a suction pad, an article holder connected with the suction pad, and a skirt extending away from the article holder toward the suction pad. The suction pad has a contact surface configured to be adhered to a support surface. The article holder connects with the suction pad. The skirt extends away from the article holder toward the suction pad and is positioned with respect to the suction pad so as to inhibit access to the suction pad when the suction pad with the article holder connected thereto is adhered to the support surface. The skirt defines an access passage when the suction pad with the article holder connected thereto is adhered to the support surface. The access passage is configured to allow an operator's finger access to the suction pad through the access passage.

Also in view of the foregoing, a suction device can include a suction pad, a suction pad connector configured to connect with a mating connector, and a release bar connected with the suction pad. The suction pad has a planar contact surface configured to be adhered to a support surface and create a partial vacuum between the support surface and the planar contact surface. The release bar has a first end or first edge disposed adjacent a peripheral edge of the suction pad and a second end or second edge spaced from the first end or first edge, respectively. The release bar and the suction pad are configured such that movement of the first end of first edge of the release bar with respect to the suction surface breaks a seal between the support surface and the planar contact surface.

### BRIEF DESCRIPTION OF THE DRAWINGS

FIG. 1 is a perspective view of a suction device including a suction pad and an article holder.

FIG. 2 is another perspective view of the suction device with the suction pad removed from the article holder.

FIG. 3 is a cross-sectional view of the suction device depicted in FIG. 1.

FIG. 4 is another perspective view of the suction device with the suction pad removed from the article holder.

FIG. 5 is a perspective view of a release bar of the suction device.

FIG. 6 is a cross-sectional view of the suction device depicted in FIG. 1 showing an access passage.

FIG. 7 is a perspective view of an alternative release bar for the suction device.

### DETAILED DESCRIPTION

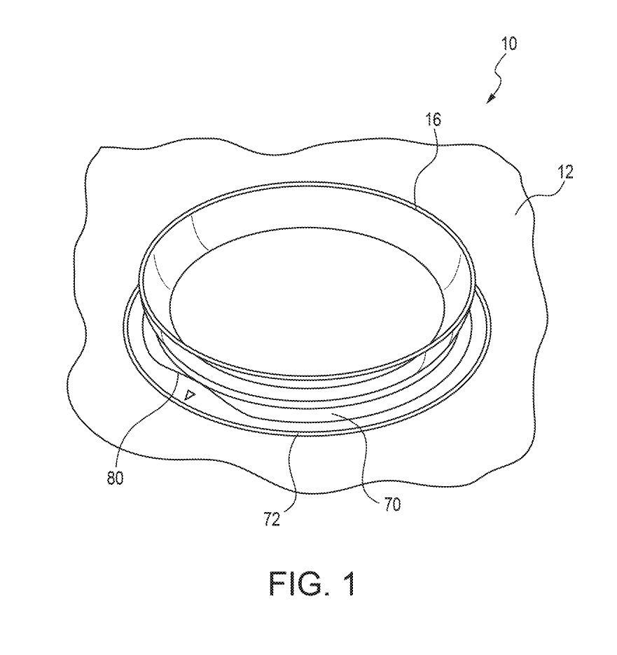

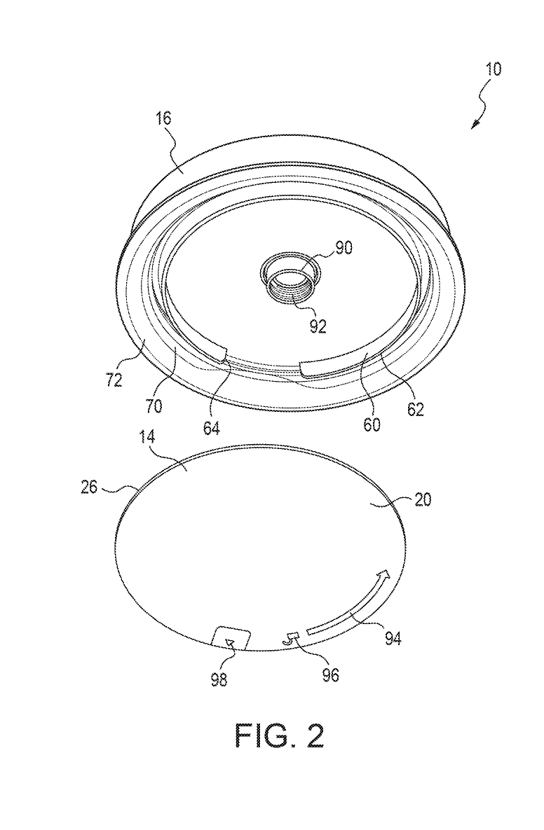

FIG. 1 depicts a suction device 10 that can be placed on a support surface 12 and can adhere to the support surface to maintain the position of the suction device 10 relative to the support surface 12. Oftentimes, the support surface 12 will be a horizontal surface such as a table, a countertop or a tray; however, the support surface 12 need not be always horizontal. With reference to FIG. 2, the suction device 10 includes a suction pad 14 and an article holder 16. The suction pad 14 connects with the article holder 16, which is shown in FIG. 1.

The suction pad 14 includes a contact surface 20 configured to be adhered to the support surface 12 and create a partial vacuum between the support surface 12 and the contact surface 20. In the illustrated embodiment, the contact surface 20 is a lower surface of the suction pad 14 that is placed on the support surface 12. The contact surface 20 is substantially flat or planar in the illustrated embodiment, which differs from many cup-shaped suction devices. By providing a planar contact surface 20, the suction device 10 requires no activation, such as the use of a mechanism to push down and pull up to create a partial vacuum between the contact surface 20 and the support surface 12.

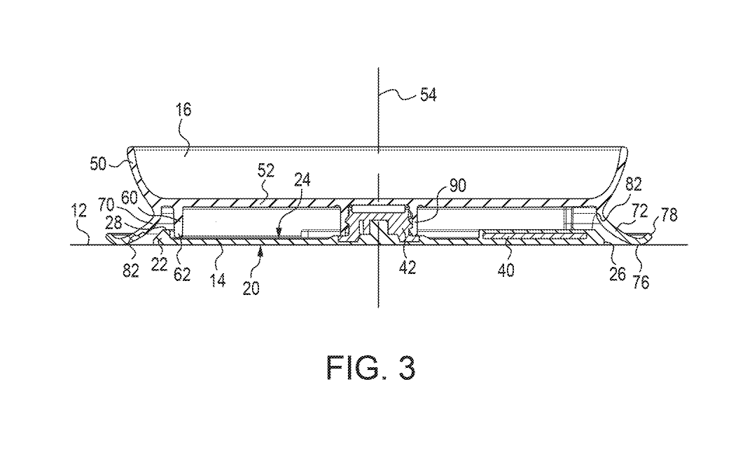

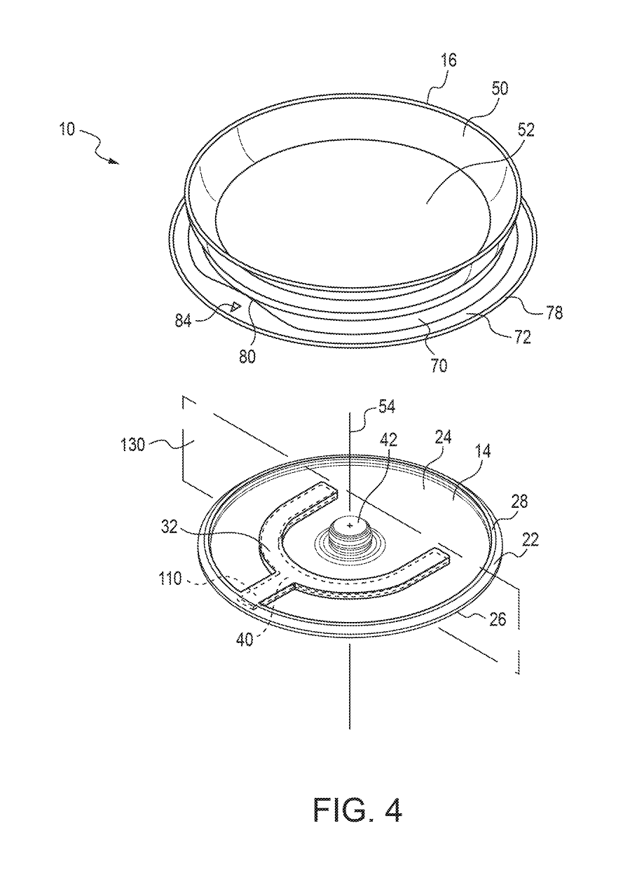

With reference to FIGS. 3 and 4, the suction pad 14 also includes a ridge 22 extending toward the article holder 16 from a non-working surface 24 of the suction pad 14, which is opposite to the contact surface 20. In the illustrated embodiment, the ridge 22 extends upwardly from the non-working surface 24, which is an upper surface of the suction pad 14 per the orientation shown in FIGS. 3 and 4. The ridge 22 is located adjacent a peripheral edge 26 of the suction pad 14. The ridge 22 stiffens the suction pad 14, which keeps the suction pad 14 from wrinkling or buckling. The ridge 22 can also weigh down the suction pad 14 along the peripheral edge 26 when the suction pad 14 is offset from the support surface 12. This also allows for the suction pad 14 to curve into a general dome shape when offset from the support surface 12 which facilitates adherence to the support surface 12 without activation as described above. The ridge 22 extends from the non-working surface 24 to a peak 28 and can be beveled or chamfered as shown in the illustrated embodiment.

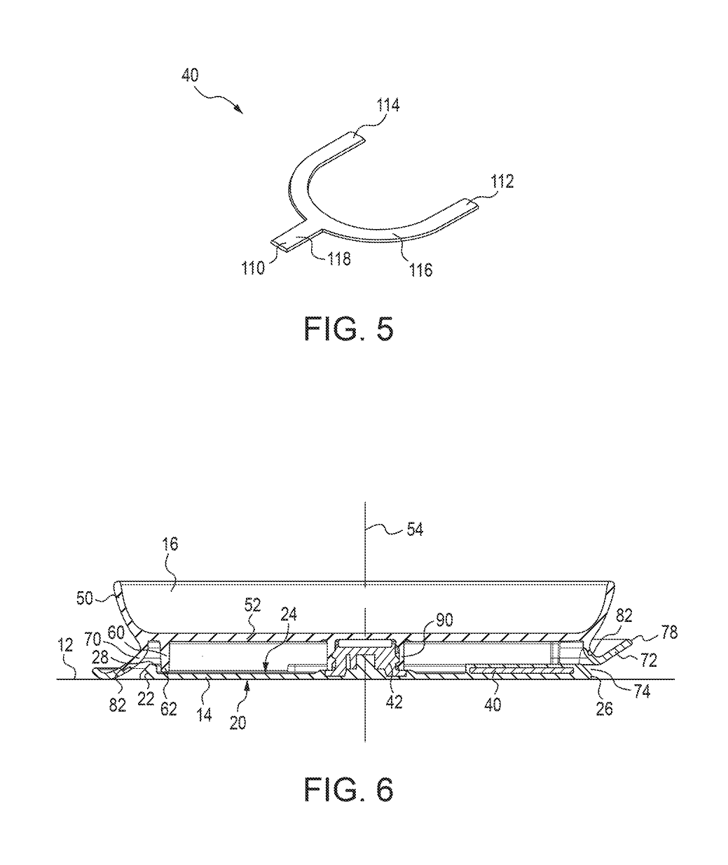

The suction pad 14 in the illustrated embodiment is made from a flexible material such as silicone. The non-working surface 24 is flat or planar in the illustrated embodiment. A release bar overmold feature 32 extends toward the article holder 16 from the non-working surface 24 of the suction pad 14. Like the ridge 22, the release bar overmold feature 32 extends upwardly from the non-working surface 24 in the illustrated embodiment. A release bar 40, which will be described in more detail below, connects with the suction pad 14 and facilitates removal of the suction pad 14 from the support surface 12. The release bar 40 shown in FIG. 5 is depicted as removed from the suction pad 14. The suction pad 14 can be molded over the release bar 40 to connect the release bar 40 with the suction pad 14. Accordingly, FIG. 4 depicts the suction pad 14 having the release bar overmold feature 32 raised from the non-working surface 24 to accommodate the release bar 40.

As mentioned above, the suction pad 14 connects with the article holder 16. A suction pad connector 42 is provided in the illustrated embodiment to facilitate the connection between the suction pad 14 and the article holder 16. In the illustrated embodiment, the suction pad connector 42 is a threaded post. Like the release bar 40, the suction pad connector 42 connects with the suction pad 14 by molding the suction pad 14 over a lower portion of the suction pad connector 42. The suction pad connector 42 can connect with the suction pad 14 in other conventional manners. The suction pad 14 can connect with the article holder 16 in other known manners and a more permanent connection between the suction pad 14 and the article holder 16 could be provided. Allowing the suction pad 14 to be disconnected from the article holder 16 can allow for easier cleaning of the suction device 10.

The article holder 16 in the illustrated embodiment is a bowl having a side wall 50 and a base 52. The article holder 16 depicted in the illustrated embodiment is just one example of an article holder that can be used with the suction device 10. For example, the article holder could be a plate or a bowl having separated compartments. The article holder could also be some sort of kitchen utensil where it would be useful to maintain the relative position of the kitchen utensil with respect to the support surface 12. The article holder could also be another type of device where it would be useful to maintain the relative position of the device with respect to the support surface 12 through the use of suction, and should not be limited to only the bowl-shaped article holder 16 depicted in the illustrated embodiment.

In the illustrated embodiment, the article holder 16 connects with the suction pad 14 such that the article holder 16 rocks with respect to the support surface 12 when the suction pad 14 with the article holder 16 connected thereto is adhered to the support surface 12. With reference to FIG. 3, the article holder 16 rocks about a wobble axis 54, which is also coaxial with the central axis of the suction pad connector 42, with respect to the support surface 12 when the suction pad 14 with the article holder 16 connected thereto is adhered to the support surface 12 and a force is applied to the article holder 16 offset from the wobble axis 54. In the illustrated embodiment, the article holder 16 rocks very little with respect to the suction pad 14 and the support surface 12 about the wobble axis 54 and this rocking or wobbling movement is limited by a rib 60 extending from the article holder 16 toward the suction pad 14. As seen in FIG. 3, the rib 60 extends downwardly from the base 52 of the article holder 16. The rib 60 includes a distal edge 62 that is offset from the non-working surface 24 of the suction pad 14 when the article holder 16 is connected with the suction pad 14 and the article holder 16 is not rocked, or at rest, with respect to the support surface 12. When a force is applied to the article holder 16 at a location offset from the wobble axis 54, the distal edge 62 of the rib 60 in the vicinity where the force is being applied is moved toward suction pad 14 and contacts the non-working surface 24 of the suction pad 14 to limit the rocking or wobbling movement of the article holder 16 with respect to the suction pad 14 and the support surface 12. The distal edge 62 of the rib 60 is also positioned nearer to the non-working surface 24 of the suction pad 14 as compared to the peak 28 of the ridge 22 when the article holder 16 is connected with the suction pad 14 and the article holder 16 is not rocked with respect to the support surface 12. As more clearly seen in FIG. 2, the rib 60 is interrupted to define a passage 64. When the suction pad 14 is connected with the article holder 16, the release bar 40 extends through the passage 64.

A skirt, which in the illustrated embodiment is made up of a rigid skirt 70 and a flexible skirt 72, extends away from the article holder 16. In the illustrated embodiment, the article holder 16, the rib 60, and the rigid skirt 70 are all made from the same material, which can be a rigid plastic material. The flexible skirt 72, on the other hand, is made from a flexible material, such as a silicone or flexible rubber-like material such that the flexible skirt 72 is moveable with respect to the article holder 16 and the rigid skirt 70.

With reference to FIG. 6, the skirt, which in the illustrated embodiment is made up of the rigid skirt 70 and the flexible skirt 72, defines an access passage 74 when the suction pad 14 with the article holder 16 connected thereto is adhered to the support surface 12. The access passage 74 is configured to allow an operator's finger access to the suction pad 14 through the access passage 74. The flexible skirt 72 extends away from the article holder 16 in a generally downward and outward direction per the orientation shown in FIG. 1. The flexible skirt 72 extends away from the article holder 16 toward the suction pad 14. As more clearly seen in FIG. 1, the flexible skirt 72 is positioned with respect to the suction pad 14 so as to obscure the suction pad 14 from view when the suction pad 14 with the article holder 16 connected thereto is adhered to the support surface 12. When the suction device 10 is used as a food receptacle for small children, the rigid skirt 70 and the flexible skirt 72 obscure the suction pad 14 from the view of the child which inhibits the child from manipulating the suction pad 14 thus reducing the likelihood that the child could dislodge the suction pad 14 from the support surface 12 and tip over the suction device 10 having food disposed in the article holder 16. The rigid skirt 70 and the flexible skirt 72 can inhibit access to the suction pad 14; however, the flexible skirt 72 is moveable with respect to the article holder 16 so that a person supervising the child can access the suction pad 14 to remove the suction device 10 from the support surface 12 when desired. In the illustrated embodiment, the flexible skirt 72 surrounds an entirety of the peripheral edge 26 of the suction pad 14. Alternatively, the flexible skirt 72 could surround at least a majority of the peripheral edge 26 of the suction pad 14.

With reference to FIG. 3, an outermost surface 76 of the flexible skirt 72, which is normal to the wobble axis 54, is coplanar with the contact surface 20 of the suction pad 14 when the suction pad 14 with the article holder 16 connected thereto is adhered to the support surface 12. As illustrated in FIG. 3, the outermost surface 76 is also the lower most surface of the flexible skirt 72. In an alternative arrangement, the outermost surface 76 could be offset slightly above the contact surface 20 of the suction pad 14 while still obscuring the suction pad 14 from view and the access passage 74 could surround the suction pad 14. The flexible skirt 72 flares outwardly and upwardly from the outermost surface 76 to a free edge 78. With reference to FIG. 3, the ridge 22 on the suction pad 14 is offset inwardly form the flexible skirt 72. Also, the rib 60 is also offset inwardly from the ridge 22 on the suction pad 14.

The rigid skirt 70 extends away from the article holder 16 between the article holder 16 and the flexible skirt 72. The flexible skirt 72 extends away from the rigid skirt 70. With reference to FIG. 4, the rigid skirt 70 includes a cut-out portion 80 where a rigid skirt distal edge 82 (FIG. 3) of the rigid skirt 70 is closer to the article holder 16 as compared to the rigid skirt distal edge 82 along a non-cut-out portion of the rigid skirt 70, which is more clearly visible when comparing the right side of FIG. 3 to the left side of FIG. 3. Access to the release bar 40 is provided through the cut-out portion 80 of the rigid skirt 70 and an indicia, such as an arrow 84, can provided on the flexible skirt 72 to provide a person information on how to gain access to the release bar 40. The cut-out portion 80 of the rigid skirt 70 is aligned with the passage 64 provided in the rib 60 when the suction pad 14 is connected with the article holder 16 in a use configuration, which is shown in FIG. 3. The flexible skirt 72 can cover the access passage 74 and be moved by the operator to provide access to the suction pad 14, which is apparent when comparing FIG. 3 to FIG. 6. Alternatively, the flexible skirt 72 can be omitted or not cover the access passage 74 while the access passage 74 can still be configured to allow an operator's finger access to the suction pad 14 through the access passage 74.

With reference to FIG. 2, an article holder connector 90 is provided to connect the article holder 16 with the suction pad 14. In the illustrated embodiment, the article holder connector 90 is a threaded boss having a cavity 92 to receive the suction pad connector 42. With reference to FIG. 2, indicia such as a rotational arrow 94, an unlocked lock 96, and an arrowhead 98 can be provided on the contact surface 20 of the suction pad 14. The rotational arrow 94 provides an indication for removing, or “unlocking” the suction pad 14 from the article holder 16. The arrowhead 98 aligns with the arrow 84 (FIG. 4) when the article holder 16 is connected with the suction pad 14 in a use configuration, which for the illustrated embodiment is when the suction pad connector 42 is fully tightened into the article holder connector 90. As explained above, the article holder 16 can connect with suction pad 14 in other conventional manners and may be connected in a more permanent manner.

The release bar 40 is provided to facilitate removal of the suction pad 14 from the support surface 12. The release bar 40 is connected with the suction pad 14 and has a first end 110 disposed adjacent the peripheral edge 26 of the suction pad and a second end (in the illustrated embodiment there are two second ends 112, 114) spaced inwardly from the peripheral edge 26. The release bar 40 and the suction pad 14 are configured such that movement of the first end 110 of the release bar 40 toward the article holder 16 breaks a seal between the support surface 12 and the contact surface 20 so that there is no longer a partial vacuum between the support surface 12 and the contact surface 20. When the first end 110 of the release bar 40 is moved away from the support surface 12, the release bar 40 pivots about the second ends 112, 114.

The release bar 40 in the illustrated embodiment has a general wishbone shape including a U-shaped section 116 that terminates at the respective second ends 112, 114. A central section 118 extends from a midpoint of the U-shaped section 116 toward the first end 110.

With reference to FIG. 4, the first end 110 of the release bar 40 is angularly offset equally in both a clockwise and a counter clockwise direction with respect to the wobble axis 54 from a plane on which the wobble axis 54 is disposed, and the second ends 112, 114 of the release bar 40 are disposed on an opposite side of the plane 130 from the first end 110. In the illustrated embodiment, the plane 130 is a vertical plane along a diameter of the suction pad 14 so that the first end 110 is on one side of the diameter and the second ends 112, 114 are on the opposite side of the diameter.

The release bar 40 extends through the passage 64 in the rib 60 when the suction pad 14 is connected with the article holder 16 in the use configuration. The first end 110 of the release bar 40 is also aligned with the cut-out portion 80 of the rigid skirt 70 when the suction pad 14 is connected with the article holder 16 in a use configuration.

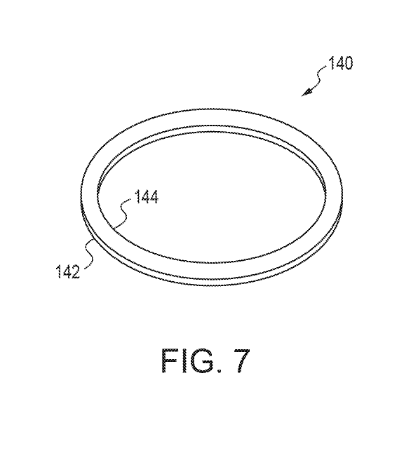

FIG. 7 depicts an alternative release bar 140 that can connect with the suction pad 14 instead of the release bar 40. The release bar 140 in this embodiment is ring shaped having a first (outer) edge 142 and a second (inner) edge 144. The release bar 140 can connect with the suction pad 14 in a manner similar to the release bar 40, e.g., the suction pad 14 can be overmolded around the release bar 140. The release bar 140 can connect in other conventional manners. In the embodiment having the release bar 140, the first edge 142 is disposed adjacent the peripheral edge 26 of the suction pad 14 and the second edge 144 is spaced inwardly from the first edge 142. The release bar 140 and the suction pad 14 are configured such that movement of the first edge 142 of the release bar 140 toward the article holder 16 breaks a seal between the support surface 12 and the contact surface 20.

In use, the suction device 10 is placed on the support surface 12 such that the contact surface 20, which can be planar (i.e., not cup-shaped), creates a partial vacuum between the contact surface 20 and the support surface 12. The article holder 16 is then precluded from movement with respect to the support surface 12 by the partial vacuum created between the support surface 12 and the contact surface 20. To release the suction device 10 from the support surface 12, an operator raises the flexible skirt 72 at the cut-out portion 80 of the rigid skirt 70. At this time, the portion of the suction pad 14 adjacent the first end 110 or the first edge 142 of the release bar 40, 140, respectively, is exposed and the operator can lift the suction pad 14 near the first end 110 or the first edge 142 and move the first end 110 or first edge 142 upwardly toward the article holder 16. In the embodiment with the release bar 40 depicted in FIG. 5, the release bar 40 thus pivots at the second ends 112, 114 and the partial vacuum between the support surface 12 and the contact surface 20 is broken so that the suction device can be released from the support surface. In the embodiment with the release bar 140 depicted in FIG. 6, the release bar 140 thus pivots at a location diametrically opposed from the lifting location and the partial vacuum between the support surface 12 and the contact surface 20 is broken.

The suction device 10 has been described above with particularity. Modifications and alterations will occur to those upon reading and understanding the preceding detailed description. For example, the shape of the suction pad 14 as well as the shape of the release bar 40, 140 could be modified without departing from the scope of the invention. For example, a C-shaped release bar (e.g., similar to the release bar 140, but not completely annular in shaped) or a segmented or discontinuous ring could be provided. Also, many other types of article holders could be attached to the suction pad. All such modifications and alterations are intended to be covered by the appended claims and the equivalents thereof.

1. A suction device comprising:
a suction pad having a contact surface configured to be adhered to a support surface;
an article holder connected with the suction pad; and
a skirt extending away from the article holder toward the suction pad and positioned with respect to the suction pad so as to inhibit access to the suction pad when the suction pad with the article holder connected thereto is adhered to the support surface, and the skirt defines an access passage when the suction pad with the article holder connected thereto is adhered to the support surface, the access passage being configured to allow an operator to access to the suction pad through the access passage.

2. The suction device of claim 1, wherein the suction pad includes a ridge extending toward the article holder from a non-working surface, which is opposite the contact surface, of the suction pad.

3. The suction device of claim 2, wherein the ridge is located adjacent a peripheral edge of the suction pad and is offset inwardly from the skirt.

4. The suction device of claim 2, further comprising a rib extending away from the article holder toward the suction pad, wherein the ridge is offset outwardly from the rib.

5. The suction device of claim 4, wherein the article holder is connected with the suction pad such that the article holder rocks about a wobble axis with respect to the support surface when the suction pad with the article holder connected thereto is adhered to the support surface and a force is applied to the article holder offset from the wobble axis, wherein the distal edge of the rib is positioned nearer to the non-working surface of the suction pad as compared to a peak of the ridge when the article holder is connected with the suction pad and the article holder is not rocked with respect to the support surface.

6. The suction device of claim 4, wherein the article holder is connected with the suction pad such that the article holder rocks about a wobble axis with respect to the support surface when the suction pad with the article holder connected thereto is adhered to the support surface and a force is applied to the article holder offset from the wobble axis, wherein the rib includes a distal edge that is offset from the non-working surface of the suction pad when the article holder is connected with the suction pad and the article holder is not rocked with respect to the support surface.

7. The suction device of claim 1, further comprising a release bar connected with the suction pad, the release bar having a portion configured to be moved by an operator away from the support surface so as to move the suction pad with respect to the support surface to which the suction pad is adhered.

8. The suction device of claim 7, wherein the article holder is connected with the suction pad such that the article holder rocks about a wobble axis with respect to the support surface when the suction pad with the article holder connected thereto is adhered to the support surface and a force is applied to the article holder offset from the wobble axis, and a first end of the release bar is angularly offset equally in both a clockwise and a counter clockwise direction from a plane on which the wobble axis is disposed, and a second end of the release bar is disposed on an opposite side of the plane from the first end.

9. The suction device of claim 8, wherein the release bar includes a pair of second ends and each second end is disposed on the opposite side of the plane from the first end.

10. The suction device of claim 7, wherein the release bar is ring shaped.

11. The suction device of claim 1, wherein the article holder is connected with the suction pad such that the article holder rocks about a wobble axis with respect to the support surface when the suction pad with the article holder connected thereto is adhered to the support surface and a force is applied to the article holder offset from the wobble axis, wherein the skirt is a flexible skirt and an outermost surface of the flexible skirt normal to the wobble axis is coplanar with the contact surface of the suction pad when the suction pad with the article holder connected thereto is adhered to the support surface.

12. The suction device of claim 1, wherein the skirt includes a rigid skirt and a flexible skirt, the rigid skirt extending away from the article holder between the article holder and the flexible skirt extends away from the rigid skirt, wherein the rigid skirt includes a cut-out portion where a rigid skirt distal edge is closer to the article holder as compared to the rigid skirt distal edge along a non cut-out portion of the rigid skirt.

13. The suction device of claim 1, further comprising a rib extending away from the article holder toward the suction pad, wherein the article holder is connected with the suction pad such that the article holder rocks about a wobble axis with respect to the support surface when the suction pad with the article holder connected thereto is adhered to the support surface and a force is applied to the article holder offset from the wobble axis, wherein the rib includes a distal edge that is offset from the non-working surface of the suction pad when the article holder is connected with the suction pad and the article holder is not rocked with respect to the support surface.

14. A suction device comprising:
a suction pad having a planar contact surface configured to be placed on a support surface and create a partial vacuum between the planar contact surface and the support surface;
a suction pad connector connected with the suction pad and configured to connect with a mating connector; and
a release bar connected with the suction pad, the release bar having a first end or a first edge disposed adjacent a peripheral edge of the suction pad and a second end or a second edge spaced from the first end or the first edge, respectively, the release bar and the suction pad being configured such that movement of the first end or the first edge of the release bar with respect to the support surface breaks a seal between the support surface and the planar contact surface.

15. The suction device of claim 14, wherein the first end of the release bar is configured to be moved by an operator away from the support surface so as to pivot the release bar about the second end.

16. The suction device of claim 14, wherein the release bar is ring shaped having the first edge disposed adjacent to the peripheral edge of the suction pad.

17. The suction device of claim 14, further comprising an article holder configured to connect with the suction pad via the suction pad connector and a rib extending downwardly from the article holder, wherein the article holder rocks with respect to the support surface when the suction pad with the article holder connected thereto is adhered to the support surface, and the rib includes a distal edge that is offset from a non-working surface of the suction pad, which is opposite the contact surface, when the article holder is connected with the suction pad and the article holder is not rocked with respect to the support surface.

18. The suction device of claim 14, further comprising an article holder configured to connect with the suction pad via the suction pad connector, a rigid skirt extending downwardly from the article holder between the article holder and a flexible skirt extending away from the rigid skirt, wherein the flexible skirt is movable with respect to the article holder and the flexible skirt inhibits access to the suction pad when the suction pad with the article holder connected thereto is placed on the support surface.

19. The suction device of claim 15, further comprising an article holder configured to connect with the suction pad via the suction pad connector, wherein the article holder rocks about a wobble axis and the first end of the release bar is angularly offset equally in both a clockwise and a counter clockwise direction from a plane on which the wobble axis is disposed, and the second end of the release bar is disposed on an opposite side of the plane from the first end.

20. The suction device of claim 19, wherein the release bar includes a pair of second ends.
